(19) United States
(12) Patent Application Publication
(10) Pub. No.: US 2009/0065555 A1
(43) Pub. Date: Mar. 12, 2009

(54) ELECTRICAL INTERCONNECT FORMING METHOD

(76) Inventors: Stephen Leslie Buchwalter, Hopewell Junction, NY (US); Peter A. Gruber, Mohegan Lake, NY (US); Da-Yuan Shih, Poughkeepsie, NY (US)

Correspondence Address: SCHMEISER, OLSEN & WATTS, 22 CENTURY HILL DR., SUITE 302, LATHAM, NY, 12110, US

(21) Appl. No.: 11/854,008

(22) Filed: Sep. 12, 2007

(51) Int. Cl. B23K 31/02

(52) U.S. Cl. 228/121; 228/135

(57) ABSTRACT

An electrical structure method of forming. The method includes forming a plurality of individual metallic structures from metallic layer formed over a first substrate. A plurality of vias are formed within a second substrate. The plurality of vias are positioned over and surrounding the plurality of metallic structures. A portion of each via is filled with solder to form solder structure surrounding an exterior surface of each metallic structure. The first substrate is removed from the metallic structures. The metallic structures comprising the solder structures are positioned over a third substrate comprising a plurality of electrically conductive pads. The metallic structures comprising the solder structures are heated to a temperature sufficient to cause the solder to melt and form an electrical and mechanical connection between each metallic structure and an associated electrically conductive pad. The second substrate is removed from the individual metallic structures.

### FIELD OF THE INVENTION

The present invention relates to an electrical interconnect structure and associated method for forming an electrical interconnect structure.

### BACKGROUND OF THE INVENTION

Forming interconnections for connecting structures together typically comprises a complicated and unreliable process. Accordingly, there exists a need in the art to overcome at least one of the deficiencies and limitations described herein above.

### SUMMARY OF THE INVENTION

The present invention provides a method for forming an electrical structure comprising:

providing a first substrate structure comprising a non-solder metallic layer formed over a first substrate, said non-solder metallic layer not comprising any solder material;

forming a plurality of metallic structures from said non-solder metallic layer, wherein each metallic structure of said plurality of metallic structures is independent from each other metallic structure of said plurality of metallic structures, and wherein each metallic structure is mechanically attached to said first substrate;

providing a second substrate;

forming a plurality of through hole vias within said second substrate, wherein each through hole via of said plurality of through hole vias extends through a top side and a bottom side of said second substrate;

positioning said second substrate comprising said plurality of through hole vias over said plurality of metallic structures such that each said through hole via is placed over and surrounding an associated metallic structure of said plurality of metallic structures;

filling, after said positioning said second substrate, a portion of each said through hole via with molten solder such that after a cooling process is performed, individual layers of solder are formed surrounding an exterior surface of each said metallic structure, wherein performing said positioning said second substrate and said filling in combination result in formation of an interconnection structure comprising said first substrate, said second substrate, and said metallic structures comprising said individual layers of solder surrounding said exterior surface of each said metallic structure;

removing said first substrate from said interconnection structure;

positioning, after said removing said first substrate, said interconnection structure over a third substrate comprising a plurality of electrically conductive pads such that each said metallic structure is in contact with an associated electrically conductive pad of said plurality of electrically conductive pads;

heating said interconnection structure to a temperature sufficient to cause said individual layers of solder to melt and form an electrical and mechanical connection between each said metallic structure and each said associated electrically conductive pad; and

removing said second substrate from said interconnection structure.

The present invention provides a method for forming an electrical structure comprising:

providing a first substrate structure comprising a non-solder metallic layer formed over a first substrate and an adhesive layer mechanically connecting said non-solder metallic layer to said first substrate, said non-solder metallic layer not comprising any solder material;

forming a plurality of metallic structures from said non-solder metallic layer, wherein each metallic structure of said plurality of metallic structures is independent from each other metallic structure of said plurality of metallic structures, and wherein said adhesive layer mechanically attaches each said metallic structure to said first substrate;

providing a second substrate;

forming a plurality of through hole vias within said second substrate, wherein each through hole via of said plurality of through hole vias extends through a top side and a bottom side of said second substrate;

positioning said second substrate comprising said plurality of through hole vias over said plurality of metallic structures such that each said through hole via is placed over and surrounding an associated metallic structure of said plurality of metallic structures;

filling, after said positioning said second substrate, a portion of each said through hole via with molten solder such that after a cooling process is performed, individual layers of solder are formed surrounding an exterior surface of each said metallic structure, wherein performing said positioning said second substrate and said filling in combination result in formation of an interconnection structure comprising said first substrate, said second substrate, said metallic structures comprising said individual layers of solder surrounding said exterior surface of each said metallic structure, and said adhesive layer;

positioning, said interconnection structure over a third substrate comprising a plurality of electrically conductive pads such that each said metallic structure is in contact with an associated electrically conductive pad of said plurality of electrically conductive pads;

heating said interconnection structure to a temperature sufficient to cause said individual layers of solder to melt and form an electrical and mechanical connection between each said metallic structure and each said associated electrically conductive pad; and

removing said first substrate, said second substrate, and said adhesive layer from said interconnection structure.

The present invention advantageously provides a simple structure and associated method for forming interconnections for connecting structures together.

### BRIEF DESCRIPTION OF THE DRAWINGS

FIGS. 1A-1I illustrate a process for generating the electrical structure of FIG. 1J, in accordance with embodiments of the present invention.

FIG. 1J illustrates the electrical structure generated by the process illustrated in FIGS. 1A-1I, in accordance with embodiments of the present invention.

FIG. 1K illustrates electrical interconnection structure, in accordance with embodiments of the present invention.

FIGS. 2A-2G illustrate a process for generating the electrical structure of FIG. 2H, in accordance with embodiments of the present invention.

FIG. 2H illustrates the electrical structure generated by the process illustrated in FIGS. 2A-2G, in accordance with embodiments of the present invention.

### DETAILED DESCRIPTION OF THE INVENTION

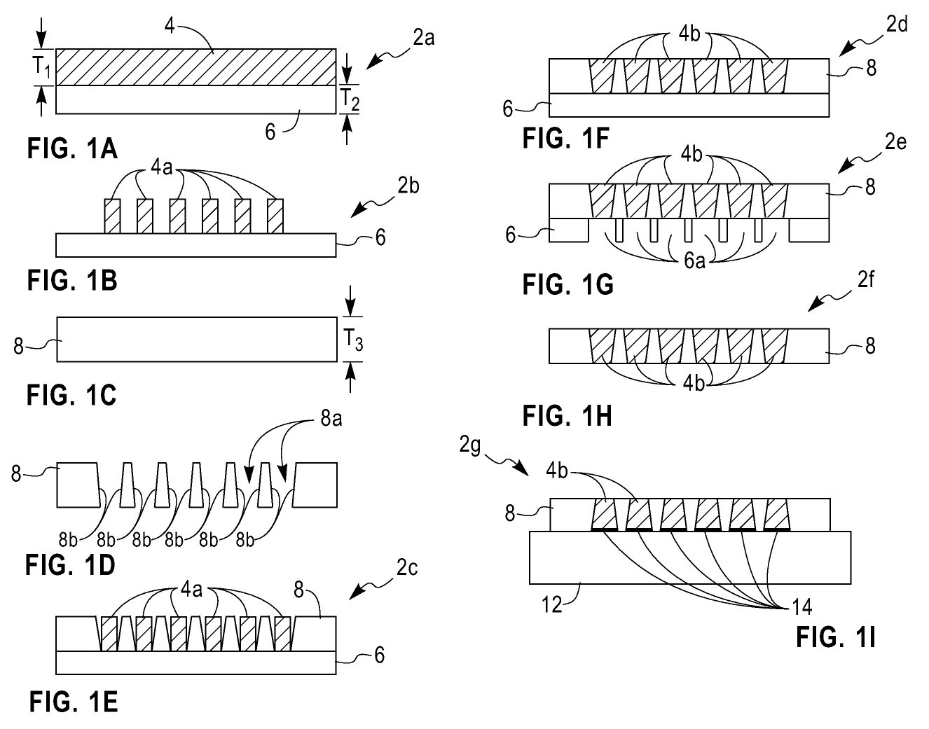

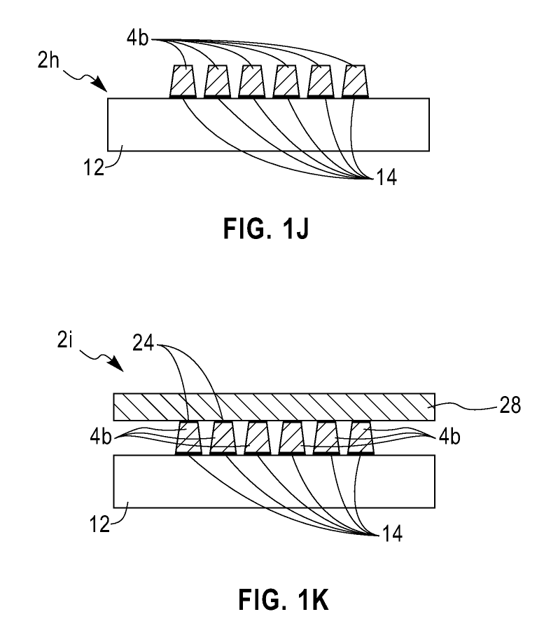

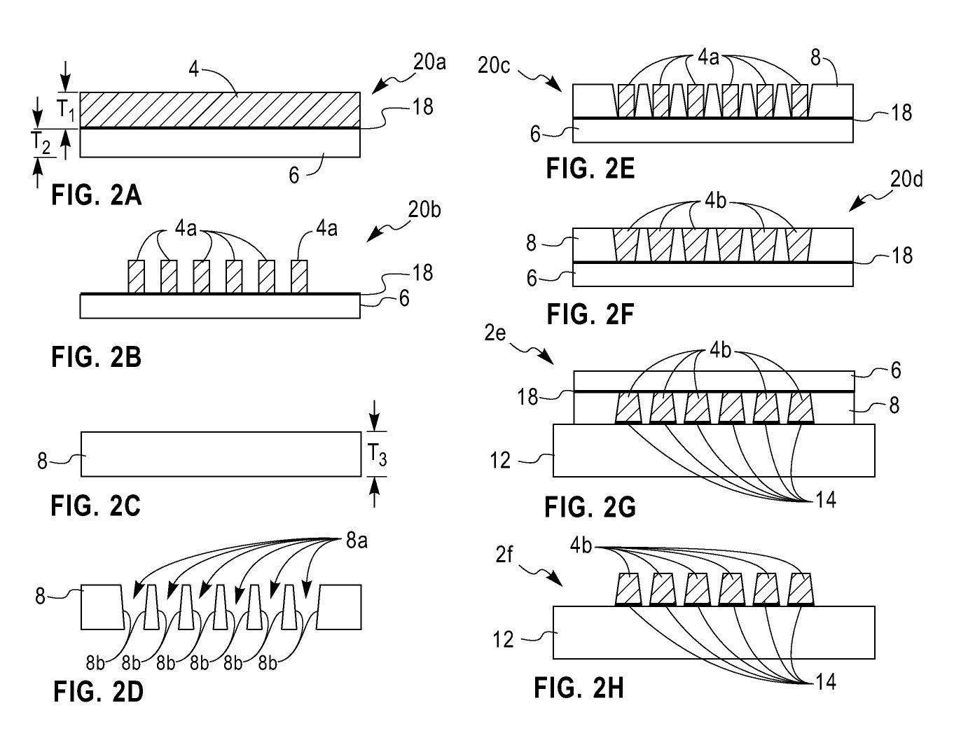

FIGS. 1A-1I illustrate a process for generating electrical structure 2h of FIG. 1J, in accordance with embodiments of the present invention. FIGS. 1A-1J illustrate a process for fabricating a composite area array interconnect structure (e.g., as shown by electrical structure 2h of FIG. 1J) consisting of a metal core (e.g., copper) surrounded by a layer of solder. The composite area array interconnect structure is used to electrically connect a first substrate (e.g., a semiconductor device (an integrated circuit chip, a semiconductor wafer, etc), a chip carrier (organic or inorganic), a printed circuit board, etc.) to a second substrate (e.g., a semiconductor device (an integrated circuit chip, a semiconductor wafer, etc), a chip carrier (organic or inorganic), a printed circuit board, etc.) as illustrated by structure 2i of FIG. 1K.

FIG. 1A illustrates a cross sectional view of a composite substrate structure 2a, in accordance with embodiments of the present invention. Substrate structure 2a comprises a non-solder metallic layer 4 (i.e., does not comprise any solder material) formed over and mechanically connected to a substrate layer 6. Non-solder metallic layer 4 may comprise any conductive metallic material that does not comprise solder including, inter alia, copper, gold, etc. Substrate layer 6 may comprise, inter alia, a layer of polyimide. Non-solder metallic layer 4 comprises a thickness T1 and substrate layer 6 comprises a thickness T2. Thickness T1 and thickness T2 may comprise a thickness selected from a range of about 1 mil. to about 3 mils.

FIG. 1B illustrates a cross sectional view of composite substrate structure 2a of FIG. 1A after non-solder metallic structures 4a (i.e., electrically isolated independent interconnects) have been formed from non-solder metallic layer 4 thereby forming a structure 2b, in accordance with embodiments of the present invention. Metallic structures 4a are formed simultaneously via a patterning process. Metallic structures 4a are formed in parallel. Metallic structures 4a may comprise a cylindrical shape. Photolithographic techniques are used to define an etched pattern (i.e., non-solder metallic structures 4a) from non-solder metallic layer 4 of FIG. 1A. Alternatively, an electroplating process may be performed in order to form non-solder metallic structures 4a. In this case, photo-lithographically defined holes in a photoresist layer (i.e., not shown) formed over non-solder metallic layer 4 may be used to define non-solder metallic structures 4a and a build up process such as electro-plating may use non-solder metallic layer 4 as a seed layer.

FIG. 1C illustrates a cross sectional view of a substrate 8 polyimide layer, in accordance with embodiments of the present invention. Substrate 8 may comprise a polyimide layer. Substrate 8 comprises a thickness T3 that is about equal to thickness T1 of non-solder metallic layer 4 in FIG. 1A.

FIG. 1D illustrates a cross sectional view of substrate 8 of FIG. 1C after through hole vias 8a (i.e., holes or openings) have been formed within substrate 8, in accordance with embodiments of the present invention. Each of vias 8a are formed such that they match a design of the non-solder metallic structures 4a of FIG. 1B. Vias 8a may be generated by a non-masking technique such as programmable laser machining or ablation. Alternatively, a mask defined machining technique may be used to generate vias 8a. Typically, a laser machining produces 8a that have slightly tapered sidewalls 8b.

FIG. 1E illustrates a cross sectional view of substrate 8 of FIG. 1D positioned over substrate layer 6 such that each of vias 8a are placed over and surrounding associated non-solder metallic structures 4a thereby forming a structure 2c, in accordance with embodiments of the present invention.

FIG. 1F illustrates a cross sectional view of structure 2c of FIG. 1E after molten solder has been placed within vias 8a of substrate 8 thereby forming structure 2d, in accordance with embodiments of the present invention. Solder is defined herein as a metal alloy comprising a low melting point (i.e., about 100 degrees Celsius to about 340 degrees Celsius) that is used to join metallic surfaces together without melting the metallic surfaces. Structure 2d has been processed by a scanning injection molded solder (IMS) apparatus which provides molten solder into vias 8a thereby surrounding an exterior surface of each of non-solder metallic structures 4a with a layer of solder. After molten solder is placed into vias 8a, the solder is allowed to cool in order to solidify the solder layer. Resulting structures 4b are formed by the aforementioned steps. Each of structures 4b comprise a layer of solder completely surrounding an exterior surface of associated non-solder metallic structure 4a.

FIG. 1G illustrates a cross sectional view of structure 2d of FIG. 1F after through hole vias 6a have been formed in substrate 6 thereby forming structure 2e, in accordance with embodiments of the present invention. Vias 6a are formed in order to separate substrate 6 from substrate 8. In FIG. 1F non-solder metallic structures 4a are mechanically connected to substrate 6 and must be separated. A laser machining process may be used to remove polyimide material (i.e., from substrate 6) below each non-solder metallic structure thereby forming vias 6a. The aforementioned process releases substrate 6 from substrate 8.

FIG. 1H illustrates a cross sectional view of substrate 8 of FIG. 1G after substrate 6 has been removed thereby forming structure 2f, in accordance with embodiments of the present invention.

FIG. 1I illustrates a cross sectional view of structure 2f of FIG. 1H positioned over a substrate 12 comprising electrically conductive pads 14, in accordance with embodiments of the present invention. Each pad of electrically conductive pads 14 may be connected to wires or electrical components within substrate 12. Substrate 12 may comprise, inter alia, a semiconductor device (e.g., an integrated circuit chip, a semiconductor wafer, etc), a chip carrier (organic or inorganic), a printed circuit board, etc. Substrate 8 in FIG. 1I is aligned to and placed in contact with electrically conductive pads 14 (i.e., each of structures 4b is placed over and in contact with an associated electrically conductive pad 14). In order to mechanically connect each of structures 4b to an associated electrically conductive pad 14, structure 2g is heated above a solder melting temperature and cooled after the solder layers have connected non-solder metallic structures 4a to associated electrically conductive pads 14.

FIG. 1J illustrates a cross sectional view of structure 2g of FIG. 1I after substrate 8 has been removed thereby forming a structure 2h, in accordance with embodiments of the present invention. Structures 4b of structure 2h are used to electrically and mechanically connect electrically conductive pads 14 to electrically conductive pads on another substrate (i.e., as shown in FIG. 1K).

FIG. 1K illustrates a cross sectional view of an electrical structure 2i, in accordance with embodiments of the present invention. Electrical structure 2i comprises substrate 12, a substrate 28, and (interconnect) structures 4b. Substrate 28 comprises a plurality of electrically conductive pads 24. Each pad of electrically conductive pads 24 may be connected to wires or electrical components within substrate 28. Substrate 28 may comprise, inter alia, a semiconductor device (e.g., an integrated circuit chip, a semiconductor wafer, etc), a chip carrier (organic or inorganic), a printed circuit board, etc. Each structure 4b electrically and mechanically connects an electrically conductive pad 14 to an electrically conductive pad 24. Each structure 4b may comprise a cylindrical shape.

An example for implementation of structure 2i of FIG. 1K is described as follows:

A silicon die (e.g., substrate 12) is connected to an organic substrate (e.g., substrate 28). The silicon die has a bonding pad metallurgy comprising a TiW adhesion layer, an Ni or CrCu diffusion barrier, and a Cu wetting layer. The organic substrate bonding pad metallurgy comprises Cu and NiAu as a top wetting layer, which may be replaced by OSP (organic surface passivation) directly over a Cu pad. Lead free solder is typically used (e.g., SnCu, SnAg, SnAgCu, etc). The lead free solder may be deposited by an injection molded solder process. Commercially available polyimides may comprise Kaptons™, Apicals™ or Uplilex™ These commercially available polyimides may be used as substrate 6 and substrate 8.

The above detailed pad structures as well as solder and polyimide materials are used as described herein to generate a Cu-solder interconnect structure (structure 2i) having a height to width aspect ratio (AR) greater than standard solder bumps which collapse on reflow to an AR of less than 1. Cu-solder interconnect structure (structure 2i) comprises an AR of 1 or greater, since the Cu structure (4b) at the center of each interconnect does not collapse.

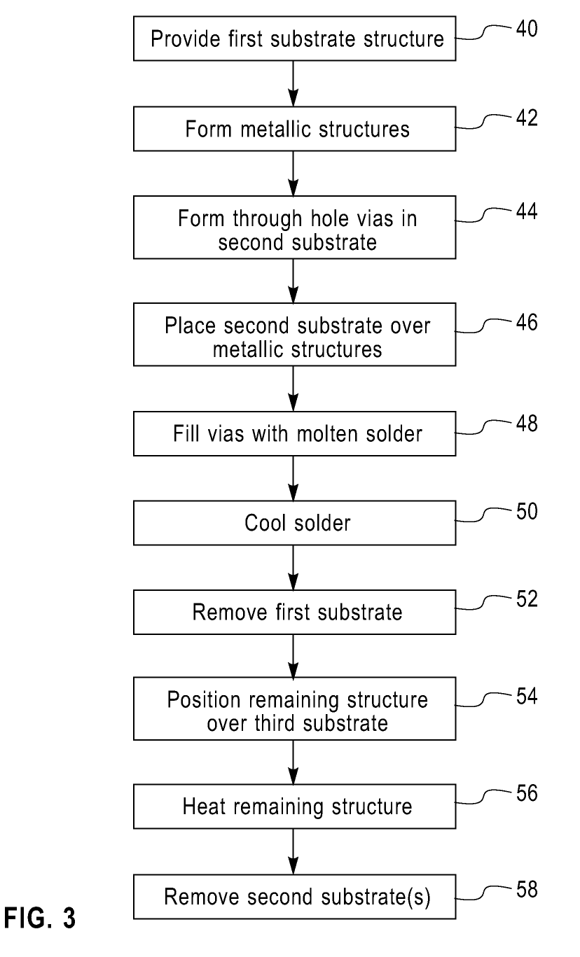

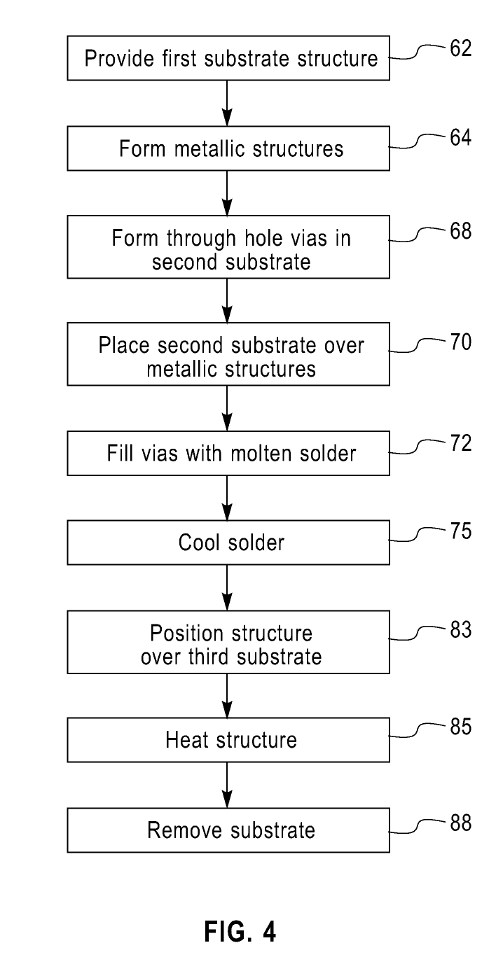

FIGS. 2A-2H illustrate an alternative process for generating electrical structure 2h of FIG. 2H in order to form structure 2i of FIG. 1K, in accordance with embodiments of the present invention. FIGS. 2A-2H illustrate a process for fabricating a composite area array interconnect structure (e.g., as shown by electrical structure 20f of FIG. 2H) consisting of a metal core (e.g., copper) surrounded by a layer of solder. The composite area array interconnect structure is used to electrically connect a first substrate (e.g., a semiconductor device (an integrated circuit chip, a semiconductor wafer, etc), a chip carrier (organic or inorganic), a printed circuit board, etc.) to a second substrate (e.g., a semiconductor device (an integrated circuit chip, a semiconductor wafer, etc), a chip carrier (organic or inorganic), a printed circuit board, etc.) as illustrated by structure 2i of FIG. 1K.

FIG. 2A illustrates a cross sectional view of a composite substrate structure 20a, in accordance with embodiments of the present invention. Substrate structure 20a comprises a non-solder metallic layer 4 (i.e., does not comprise any solder material), an adhesive layer 18, and a substrate layer 6. Adhesive layer 18 mechanically attaches non-solder metallic layer 4 to substrate layer 6. Non-solder metallic layer 4 may comprise any conductive metallic material that does not comprise solder including, inter alia, copper, gold, etc. Substrate layer 6 may comprise, inter alia, a layer of polyimide. Adhesive layer 18 may comprise, inter alia, acrylate, etc. Non-solder metallic layer 4 comprises a thickness T1 and substrate layer 6 comprises a thickness T2. Thickness T1 and thickness T2 may comprise a thickness selected from a range of about 1 mil. to about 3 mils.

FIG. 2B illustrates a cross sectional view of composite substrate structure 20a of FIG. 2A after non-solder metallic structures 4a (i.e., interconnects) have been formed from non-solder metallic layer 4 thereby forming a structure 20b, in accordance with embodiments of the present invention. Metallic structures 4a are formed simultaneously via a patterning process. Metallic structures 4a are formed in parallel. Photolithographic techniques are used to define an etched pattern (i.e., non-solder metallic structures 4a) from non-solder metallic layer 4 of FIG. 2A. Alternatively, an electroplating process may be performed in order to form non-solder metallic structures 4a. In this case, photo-lithographically defined holes in a photo resist layer (i.e., not shown) formed over non-solder metallic layer 4 may be used to define non-solder metallic structures 4a and a build up process such as electro-plating may use non-solder metallic layer 4 as a seed layer.

FIG. 2C illustrates a cross sectional view of a substrate 8 polyimide layer, in accordance with embodiments of the present invention. Substrate 8 may comprise a polyimide layer. Substrate 8 comprises a thickness T3 that is about equal to thickness T1 of non-solder metallic layer 4 in FIG. 1A.

FIG. 2D illustrates a cross sectional view of substrate 8 of FIG. 2C after through hole vias 8a (i.e., holes or openings) have been formed within substrate 8, in accordance with embodiments of the present invention. Each of vias 8a are formed such that they match a design of the non-solder metallic structures 4a of FIG. 2B. Vias 8a may be generated by a non-masking technique such as programmable laser machining or ablation. Alternatively, a mask defined machining technique may be used to generate vias 8a. Typically, a laser machining produces 8a that have slightly tapered sidewalls 8b.

FIG. 2E illustrates a cross sectional view of substrate 8 of FIG. 2D positioned over substrate layer 6 such that each of vias 8a are placed over and surrounding associated non-solder metallic structures 4a thereby forming a structure 20c, in accordance with embodiments of the present invention.

FIG. 2F illustrates a cross sectional view of structure 20c of FIG. 2E after molten solder has been placed within vias 8a of substrate 8 thereby forming structure 2d, in accordance with embodiments of the present invention. Solder is defined herein as a metal alloy comprising a low melting point (i.e., about 100 degrees Celsius to about 340 degrees Celsius) that is used to join metallic surfaces together without melting the metallic surfaces. Structure 20d has been processed by a scanning injection molded solder (IMS) apparatus which provides molten solder into vias 8a thereby surrounding each of non-solder metallic structures 4a with a layer of solder. After molten solder is placed into vias 8a, the solder is allowed to cool in order to solidify the solder layer. Resulting structures 4b are formed by the aforementioned steps. Each of structures 4b comprise a layer of solder completely surrounding an exterior surface of associated non-solder metallic structure 4a.

FIG. 2G illustrates a cross sectional view of structure 20D of FIG. 2F positioned over a substrate 12 comprising electrically conductive pads 14, in accordance with embodiments of the present invention. Each pad of electrically conductive pads 14 may be connected to wires or electrical components within substrate 12. Substrate 12 may comprise, inter alia, a semiconductor device (e.g., an integrated circuit chip, a semiconductor wafer, etc), a chip carrier (organic or inorganic), a printed circuit board, etc. Structure 20E of FIG. 2G comprises structure 20D of FIG. 2F aligned to and placed in contact with electrically conductive pads 14 (i.e., each of structures 4b is placed over and in contact with an associated electrically conductive pad 14). In order to mechanically connect each of structures 4b to an associated electrically conductive pad 14, structure 20e is heated above a solder melting temperature and cooled after the solder layers have connected non-solder metallic structures 4a to associated electrically conductive pads 14.

FIG. 2H illustrates a cross sectional view of structure 20e of FIG. 2G after substrate 6, adhesive layer 18, and substrate 8 has been removed thereby forming a structure 20f, in accordance with embodiments of the present invention. Substrate 6, adhesive layer 18, and substrate 8 may be removed all together as one piece (i.e., simultaneously). Alternatively, substrate 6, adhesive layer 18, and substrate 8 may be removed individually (i.e., one at a time). Structures 4b of structure 20f are used to electrically and mechanically connect electrically conductive pads 14 to electrically conductive pads on another substrate (i.e., as shown in FIG. 1K).

FIG. 3 illustrates a flowchart detailing process steps for forming structure 2H of FIG. 1J, in accordance with embodiments of the present invention. In step 40, a first substrate structure is provided. The first substrate structure comprises a non-solder metallic layer formed over a first substrate. The non-solder metallic layer does comprise any solder material (i.e., a material comprising a low melting point of about 100 degrees Celsius to about 340 degrees Celsius). In step 42, a plurality of metallic structures are formed from the non-solder metallic layer. Each metallic structure of the plurality of metallic structures is independent from each other metallic structure. Each metallic structure is mechanically attached to said first substrate. The plurality of metallic structures may be formed simultaneously by, inter alia, an etching process, an electroplating process, etc. In step 44, a plurality of through hole vias are formed (e.g., by laser ablation) within a second substrate. Each through hole via extends through a top side and a bottom side of the second substrate. In step 46, the second substrate comprising the plurality of through hole vias is positioned over the plurality of metallic structures such that each through hole via is placed over and surrounding an associated metallic structure. In step 48, a portion of each through hole via is filled with molten solder thereby forming individual layers of solder surrounding an exterior surface of each metallic structure. In step 50, the individual layers of solder are cooled. Steps 46, 48, and 50, result in a formation of an interconnection structure comprising the first substrate, the second substrate, and the metallic structures comprising the individual layers of solder surrounding the exterior surface of each metallic structure. In step 52, the first substrate is removed from the interconnection structure. In step 54, the interconnection structure (without the first substrate) is positioned over a third substrate comprising a plurality of electrically conductive pads such that each said metallic structure is in contact with an associated electrically conductive pad of the plurality of electrically conductive pads. In step 56, the interconnection structure positioned over the third substrate is heated to a temperature (i.e., about 100 degrees Celsius to about 340 degrees Celsius) sufficient to cause said individual layers of solder to melt and form an electrical and mechanical connection between each metallic structure and each associated electrically conductive pad. In step 58, the second substrate is removed from the interconnection structure.

FIG. 4 illustrates a flowchart detailing process steps for forming structure 20f of FIG. 2H, in accordance with embodiments of the present invention. In step 62, a first substrate structure is provided. The first substrate structure comprises a non-solder metallic layer formed over a first substrate and an adhesive layer mechanically connecting the non-solder metallic layer to the first substrate. The non-solder metallic layer does comprise any solder material (i.e., a material comprising a low melting point of about 100 degrees Celsius to about 340 degrees Celsius). In step 64, a plurality of metallic structures are formed from the non-solder metallic layer. Each metallic structure of the plurality of metallic structures is independent from each other metallic structure. Each metallic structure is mechanically attached to the first substrate by the adhesive layer. The plurality of metallic structures may be formed by, inter alia, an etching process, an electroplating process, etc. In step 68, a plurality of through hole vias are formed (e.g., by laser ablation) within a second substrate. Each through hole via extends through a top side and a bottom side of the second substrate. In step 70, the second substrate comprising the plurality of through hole vias is positioned over the plurality of metallic structures such that each through hole via is placed over and surrounding an associated metallic structure. In step 72, a portion of each through hole via is filled with molten solder thereby forming individual layers of solder surrounding an exterior surface of each metallic structure. In step 75, the individual layers of solder are cooled. Steps 70, 72, and 75, result in a formation of an interconnection structure comprising the first substrate, the second substrate, the adhesive layer, and the metallic structures comprising the individual layers of solder surrounding the exterior surface of each metallic structure. In step 83, the interconnection structure is positioned over a third substrate comprising a plurality of electrically conductive pads such that each said metallic structure is in contact with an associated electrically conductive pad of the plurality of electrically conductive pads. In step 85, the interconnection structure positioned over the third substrate is heated to a temperature (i.e., about 100 degrees Celsius to about 340 degrees Celsius) sufficient to cause said individual layers of solder to melt and form an electrical and mechanical connection between each metallic structure and each associated electrically conductive pad. In step 88, the first substrate, the second substrate, and the adhesive layer are removed from the interconnection structure. The first substrate, the second substrate, and the adhesive layer may be removed simultaneously or individually.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for forming an electrical structure comprising:
providing a first substrate structure comprising a non-solder metallic layer formed over a first substrate, said non-solder metallic layer not comprising any solder material;
forming a plurality of metallic structures from said non-solder metallic layer, wherein each metallic structure of said plurality of metallic structures is independent from each other metallic structure of said plurality of metallic structures, and wherein each metallic structure is mechanically attached to said first substrate;
providing a second substrate;
forming a plurality of through hole vias within said second substrate, wherein each through hole via of said plurality of through hole vias extends through a top side and a bottom side of said second substrate;
positioning said second substrate comprising said plurality of through hole vias over said plurality of metallic structures such that each said through hole via is placed over and surrounding an associated metallic structure of said plurality of metallic structures;
filling, after said positioning said second substrate, a portion of each said through hole via with molten solder such that after a cooling process is performed, individual layers of solder are formed surrounding an exterior surface of each said metallic structure, wherein performing said positioning said second substrate and said filling in combination result in formation of an interconnection structure comprising said first substrate, said second substrate, and said metallic structures comprising said individual layers of solder surrounding said exterior surface of each said metallic structure;
removing said first substrate from said interconnection structure;
positioning, after said removing said first substrate, said interconnection structure over a third substrate comprising a plurality of electrically conductive pads such that each said metallic structure is in contact with an associated electrically conductive pad of said plurality of electrically conductive pads;
heating said interconnection structure to a temperature sufficient to cause said individual layers of solder to melt and form an electrical and mechanical connection between each said metallic structure and each said associated electrically conductive pad; and
removing said second substrate from said interconnection structure.

2. The method of claim 1, wherein each said metallic structure comprises a cylindrical shape.

3. The method of claim 1, wherein said non-solder metallic layer comprises a same thickness as said second substrate.

4. The method of claim 1, wherein said non-solder metallic layer comprises copper.

5. The method of claim 1, wherein said first substrate comprises polyimide, and wherein said second substrate comprises polyimide.

6. The method of claim 1, wherein a laser is used to perform said removing said first substrate from said interconnection structure.

7. The method of claim 6, wherein said laser is used to remove sections of said first substrate that are mechanically attached to said plurality of metallic structures.

8. The method of claim 1, wherein said filling comprises using an injection molded solder process to fill each said portion of each said through hole via with said molten solder.

9. The method of claim 1, wherein said forming a plurality of metallic structures from said non-solder metallic layer comprises the use of an etching process to remove portions of said non-solder metallic layer.

10. The method of claim 1, wherein said forming a plurality of metallic structures from said non-solder metallic layer comprises the use of an electroplating process to form said plurality of metallic structures.

11. The method of claim 1, wherein each said through hole via comprises tapered sidewalls.

12. A method for forming an electrical structure comprising:
providing a first substrate structure comprising a non-solder metallic layer formed over a first substrate and an adhesive layer mechanically connecting said non-solder metallic layer to said first substrate, said non-solder metallic layer not comprising any solder material;
forming a plurality of metallic structures from said non-solder metallic layer, wherein each metallic structure of said plurality of metallic structures is independent from each other metallic structure of said plurality of metallic structures, and wherein said adhesive layer mechanically attaches each said metallic structure to said first substrate;
providing a second substrate;
forming a plurality of through hole vias within said second substrate, wherein each through hole via of said plurality of through hole vias extends through a top side and a bottom side of said second substrate;
positioning said second substrate comprising said plurality of through hole vias over said plurality of metallic structures such that each said through hole via is placed over and surrounding an associated metallic structure of said plurality of metallic structures;
filling, after said positioning said second substrate, a portion of each said through hole via with molten solder such that after a cooling process is performed, individual layers of solder are formed surrounding an exterior surface of each said metallic structure, wherein performing said positioning said second substrate and said filling in combination result in formation of an interconnection structure comprising said first substrate, said second substrate, said metallic structures comprising said individual layers of solder surrounding said exterior surface of each said metallic structure, and said adhesive layer;
positioning, said interconnection structure over a third substrate comprising a plurality of electrically conductive pads such that each said metallic structure is in contact with an associated electrically conductive pad of said plurality of electrically conductive pads;
heating said interconnection structure to a temperature sufficient to cause said individual layers of solder to melt and form an electrical and mechanical connection between each said metallic structure and each said associated electrically conductive pad; and
removing said first substrate, said second substrate, and said adhesive layer from said interconnection structure.

13. The method of claim 12, wherein removing comprises individually removing said first substrate, said second substrate, and said adhesive layer from said interconnection structure.

14. The method of claim 12, wherein each said metallic structure comprises a cylindrical shape.

15. The method of claim 12, wherein said non-solder metallic layer comprises a same thickness as said second substrate.

16. The method of claim 12, wherein said non-solder metallic layer comprises copper.

17. The method of claim 12, wherein said first substrate comprises polyimide, and wherein said second substrate comprises polyimide.

18. The method of claim 12, wherein said filling comprises using an injection molded solder process to fill each said portion of each said through hole via with said molten solder.

19. The method of claim 12, wherein said forming a plurality of metallic structures from said non-solder metallic layer comprises the use of an etching process to remove a portions of said non-solder metallic layer.

20. The method of claim 12, wherein each said through hole via comprises tapered sidewalls.
